(19) United States
(12) Patent Application Publication
(10) Pub. No.: US 2010/0055017 A1
(43) Pub. Date: Mar. 4, 2010

(54) METHODS FOR THE PRODUCTION OF ULTRAFINE METAL CARBIDE PARTICLES AND HYDROGEN

(75) Inventors: Noel R. Vanier, Wexford, PA (US); Stuart D. Hellring, Pittsburgh, PA (US); Cheng-Hung Hung, Wexford, PA (US)

Correspondence Address: PPG INDUSTRIES INC;INTELLECTUAL PROPERTY DEPT, ONE PPG PLACE, PITTSBURGH, PA, 15272, US

(73) Assignee: PPG INDUSTRIES OHIO, INC., Cleveland, OH (US)

(21) Appl. No.: 12/203,420

(22) Filed: Sep. 3, 2008

(51) Int. Cl. C01B 31/36; C01B 31/30; C01B 31/34; B01J 19/08

(52) U.S. Cl. 423/291; 423/439; 422/198; 423/440; 423/345

(57) ABSTRACT

A method for producing ultrafine metal carbide particles and hydrogen is disclosed. The method includes introducing a metal-containing precursor and a carbon-containing precursor into a thermal reaction chamber, heating the precursors in the thermal reaction chamber to form the ultrafine metal carbide particles from the precursors and to form carbon monoxide and hydrogen, collecting the ultrafine doped metal carbide particles, converting at least a portion of the carbon monoxide to carbon dioxide and generating additional hydrogen, and recovering at least a portion of the hydrogen.

### GOVERNMENT CONTRACT

This invention was made with United States government support under Contract Number W911NF-05-9-0001 awarded by DARPA. The United States government has certain rights in this invention.

### FIELD OF THE INVENTION

The present invention relates to the production of ultrafine metal carbide particles, and more particularly relates to a method of producing such particles which generates hydrogen for recirculation into the ultrafine particle-forming process and for other uses.

### BACKGROUND INFORMATION

Boron carbide particles having particle sizes of greater than 0.2 micron have been produced by solid phase synthesis using B₂O₃ and carbon as starting reactant materials and subsequent milling. Such particles may be sintered to form various products such as armor panels and abrasion resistant nozzles. Sintering aids may be added to such boron carbide particles by milling in order to obtain a mixture that is homogeneous on a macro scale. However, these mixtures are not uniform on a microscale, and such non-uniformities may adversely affect sintering of the particles and cause defects in the sintered bodies that degrade mechanical properties.

### SUMMARY OF THE INVENTION

In certain respects, the present invention is directed to providing a method for producing ultrafine metal carbide particles and hydrogen comprising: introducing a metal-containing precursor and a carbon-containing precursor into a thermal reaction chamber; heating the precursors in the thermal reaction chamber to form the ultrafine metal carbide particles from the precursors and to form carbon monoxide and hydrogen; collecting the ultrafine metal carbide particles; converting at least a portion of the carbon monoxide to carbon dioxide and generating additional hydrogen; and recovering at least a portion of the hydrogen.

In other respects, the present invention is directed to providing a system for producing ultrafine metal carbide particles and hydrogen comprising: a source of metal-containing precursor; a source of carbon-containing precursor; means for introducing the metal-containing precursor and carbon-containing precursor into a thermal reaction chamber to form the ultrafine metal carbide particles from the precursors and to form carbon monoxide and hydrogen; and means for converting at least a portion of the carbon monoxide to carbon dioxide and generating additional hydrogen.

### BRIEF DESCRIPTION OF THE DRAWINGS

FIG. 1 is a flowchart depicting steps of certain methods of the present invention.

FIG. 2 is a partially schematic sectional view of an apparatus for producing ultrafine metal carbide particles, carbon monoxide and hydrogen in accordance with certain embodiments of the present invention.

FIG. 3 is a partially schematic sectional view of an apparatus for producing ultrafine metal carbide particles, carbon monoxide and hydrogen in accordance with certain embodiments of the present invention.

### DETAILED DESCRIPTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances.

Certain embodiments of the present invention are directed to methods for making ultrafine metal carbide particles and generating hydrogen for recirculation into the particle-forming process or for other uses. Examples of ultrafine metal carbides that may be produced include boron carbides such as B₄C, B₁₃C₂, B₈C, B₁₀C, B₂₅C. Other ultrafine doped metal carbides that may be produced in accordance with the present invention include tungsten carbide, titanium carbide, silicon carbide, aluminum carbide, iron carbide, zirconium carbide, magnesium aluminum carbide, hafnium carbide and the like.

As used herein, the term “ultrafine metal carbide particles” refers to metal carbide particles having a B.E.T. specific surface area of at least 5 square meters per gram, such as 20 to 200 square meters per gram, or, in some cases, 30 to 100 square meters per gram. As used herein, the term “B.E.T. specific surface area” refers to a specific surface area determined by nitrogen adsorption according to the ASTMD 3663-78 standard based on the Brunauer-Emmett-Teller method described in the periodical “The Journal of the American Chemical Society”, 60, 309 (1938).

In certain embodiments, the ultrafine metal carbide particles made in accordance with the present invention have a calculated equivalent spherical diameter of no more than 200 nanometers, such as no more than 100 nanometers, or, in certain embodiments, 5 to 50 nanometers. As will be understood by those skilled in the art, a calculated equivalent spherical diameter can be determined from the B.E.T. specific surface area according to the following equation:

Diameter (nanometers)=6000/[BET(m²/g)*ρ(grams/cm³)]

In certain embodiments, the ultrafine metal carbide particles have an average particle size of no more than 100 nanometers, in some cases, no more than 50 nanometers or, in yet other cases, no more than 30 or 40 nanometers. As used herein, the term “average particle size” refers to a particle size as determined by visually examining a micrograph of a transmission electron microscopy (“TEM”) image, measuring the diameter of the particles in the image, and calculating the average particle size of the measured particles based on magnification of the TEM image. One of ordinary skill in the art will understand how to prepare such a TEM image and determine the average particle size based on the magnification. The size of a particle refers to the smallest diameter sphere that will completely enclose the individual particle.

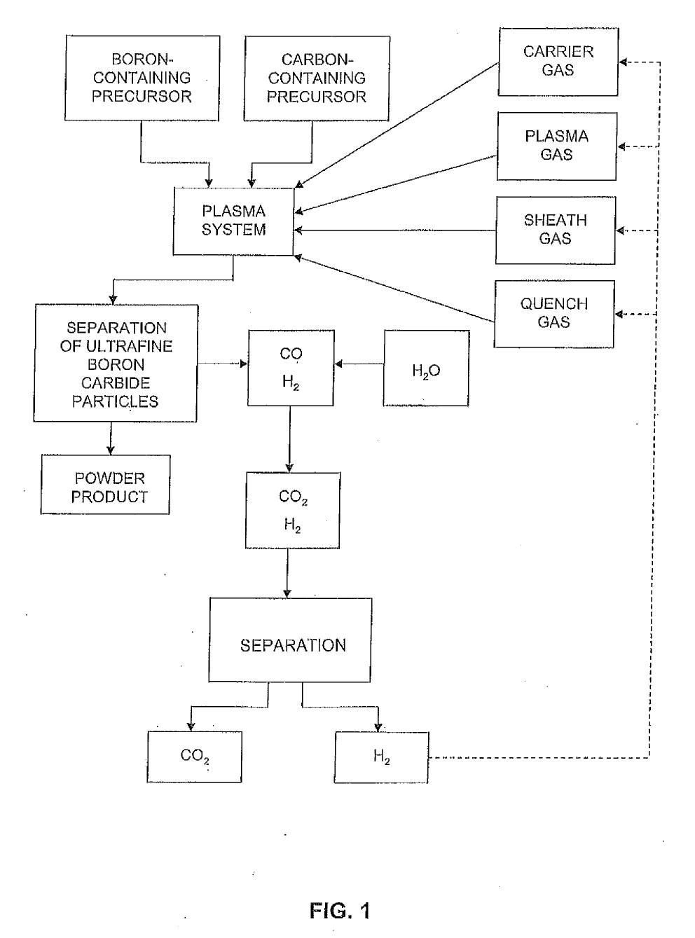

FIG. 1 is a flow diagram depicting certain embodiments of the methods of the present invention. A boron-containing precursor and carbon-containing precursor are provided as feed materials for the production of ultrafine boron carbide particles and hydrogen utilizing a thermal reaction chamber. In the embodiment shown in FIG. 1, the thermal reaction chamber comprises a plasma system. However, any other suitable type of heating process may be used in the thermal reaction chamber, such as flame spray pyrolysis, flame spraying, electric arc spraying, combustion powder, combustion wire, high velocity oxy-fuel (HVOF) deposition, electric hot wall, detonation gun deposition and super detonation gun deposition, as well as others known to those skilled in the art. In the embodiment shown in FIG. 1, the precursors are provided from two separate sources. However, the feed materials may be provided from a single source.

In certain embodiments, the boron-containing precursor may be provided in solid particulate form. For example, ultrafine boron carbide particles may be produced from B₂O₃ precursor powders. In certain embodiments, the carbon source may be carbon powder or a gas such as methane or natural gas. For example, boron-containing compounds such as B₂O₃ or borax particles may be suspended or dissolved in a carbon-containing gas such as methane or natural gas, or in an organic liquid such as methanol, glycerol, ethylene glycol or dimethyl carbonate.

In one embodiment, the metal-containing and carbon-containing precursors may be provided in liquid form. The term “liquid precursor” means a precursor material that is liquid at room temperature. In accordance with certain embodiments in which boron carbide powders are produced, suitable liquid boron-containing precursors include borate esters and other compounds containing boron-oxygen bonds. For example, the liquid boron-containing precursor may comprise trimethylboroxine, trimethylborate and/or triethylborate. The carbon-containing precursor may be in liquid form and may comprise aliphatic carbon atoms and/or aromatic carbon atoms. For example, the liquid carbon-containing precursor may comprise acetone, iso-octane and/or toluene. In certain embodiments, the liquid carbon-containing precursor may comprise an organic liquid with a relatively high C:H atomic ratio, e.g., greater than 1:3 or greater than 1:2. Furthermore, such liquid hydrocarbon precursors may also have a relatively high C:O atomic ratio, e.g., greater than 2:1 or greater than 3:1.

When B₂O₃ and C powders are used as the precursors in the presence of a H₂ carrier gas, the following formula applies:

2B₂O₃(s)+7C(s)→B₄C(s)+6CO(g).

When methane is used as the carbon-containing precursor, the following formula applies:

2B₂O₃(s)+7CH₄(g)→B₄C(s)+6CO(g)+14H₂(g).

In accordance with certain embodiments, the ratio of boron-containing precursor to carbon-containing precursor is controlled in order to control the composition of the resultant boron carbide and/or in order to control the formation of excess boron or excess carbon in the ultrafine boron carbide particles. For example, if an excess amount of boron-containing precursor is used, excess boron may form on or in the ultrafine boron carbide particles, which may react with oxygen or air to form oxide compounds. As a further example, an excess amount of carbon-containing precursor in the starting feed material may cause the formation of graphite on or in the resultant boron carbide particles.

As shown in FIG. 1, in accordance with certain methods of the present invention, a carrier gas may be introduced into the plasma of the thermal reaction chamber in addition to the boron-containing precursor and the carbon-containing precursor. The carrier may be a gas that acts to suspend or atomize the precursors in the gas, thereby producing a gas-stream in which the precursors are entrained. Suitable carrier gases include, but are not limited to, hydrogen, argon, helium, or a combination thereof. In one embodiment, the carrier gas comprises hydrogen which is generated during the particle-forming process and recirculated into the system.

Next, in accordance with certain embodiments of the present invention, the precursors and carrier gas are heated by a plasma system, e.g., as the entrained precursors flow into a plasma chamber, yielding a gaseous stream of the precursors and/or their vaporized or thermal decomposition products and/or their reaction products. In certain embodiments, the precursors are heated to a temperature ranging from 1,500° to 20,000° C., such as 1,700° to 8,000° C. Any conventionally known type of plasma gas may be used. In one embodiment, the plasma gas comprises hydrogen which is generated by the process and recirculated into the system.

In certain methods of the present invention, after the gaseous stream is produced, it is contacted with one or more quench streams that are injected into the plasma chamber through at least one quench stream injection port. For example, the quench streams are injected at flow rates and injection angles that result in impingement of the quench streams with each other within the gaseous stream. The material used in the quench streams is not limited, so long as it adequately cools the gaseous stream to facilitate the formation or control the particle size of the ultrafine doped metal carbide particles. Materials suitable for use in the quench streams include, but are not limited to, inert gases such as argon, helium, nitrogen, hydrogen gas, ammonia, mono, di and polybasic alcohols, hydrocarbons, amines and/or carboxylic acids. In one embodiment, the quench gas comprises hydrogen which is generated during the process and recirculated into the system.

In certain embodiments, the particular flow rates and injection angles of the various quench streams may vary, for example, they may impinge with each other within the gaseous stream to result in the rapid cooling of the gaseous stream. For example, the quench streams may primarily cool the gaseous stream through dilution, rather than adiabatic expansion, thereby causing a rapid quenching of the gaseous stream, before, during and/or after the formation of the ultrafine metal carbide particles prior to passing the particles into and through a converging member, such as a converging-diverging nozzle, as described below.

In certain embodiments of the invention, after contacting the gaseous product stream with the quench streams to cause production of ultrafine metal carbide particles, the ultrafine particles may be passed through a converging member, wherein the plasma system is designed to minimize the fouling thereof. In certain embodiments, the converging member also comprises a diverging section, e.g., a converging-diverging (De Laval) nozzle. In these embodiments, while the converging-diverging nozzle may act to cool the product stream to some degree, the quench streams perform much of the cooling so that a substantial amount of the ultrafine metal carbide particles are formed upstream of the nozzle. In these embodiments, the converging-diverging nozzle may primarily act as a choke position that permits operation of the reactor at higher pressures, thereby increasing the residence time of the materials therein. A sheath gas may be introduced at or upstream from the converging-diverging nozzle. In one embodiment, the sheath gas comprises hydrogen which is generated by the process and recirculated into the system.

As is seen in FIG. 1, in certain embodiments of the methods of the present invention, after the ultrafine doped metal carbide particles exit the thermal reaction chamber, they are collected as a powder product. Any suitable means may be used to separate the ultrafine particles from the gas flow, such as, for example, a bag filter, cyclone separator or deposition on a substrate.

As also seen in FIG. 1, CO and H₂ gases are generated from the plasma system, and are treated with water to form CO₂ and additional H₂ by the following water-gas shift reaction:

6CO(g)+6H₂O(g)→6CO₂(g)+6H₂(g).

This treatment of CO and H₂ gases may take place at a facility different from the facility at which the powder product is produced. In some cases, however, the facility at which the powder product is produced is integral with facility at which the CO and H₂ gases are treated, such as may be the case with, for example, an existing H₂ gas production facility or a facility that utilizes CO₂, such as a silica production facility. In certain embodiments, therefore, the methods and systems are desirably employed at an existing hydrogen gas production facility.

As seen in FIG. 1, the CO₂ and H₂ gases may be separated by, for example, standard pressure swing adsorption or membrane separation into individual streams of CO₂ and H₂. The CO₂ stream may be exhausted or otherwise disposed of. The H₂ stream may be collected and/or used for any desired purpose, including for sale or as a feedstock for industrial processes. In certain embodiments, a portion of the H₂ stream is recirculated to the plasma system, for example, as a carrier and/or quench gas. Similarly, the CO₂ stream may be collected and/or used for any desired purpose, including for sale or as a feedstock for industrial processes.

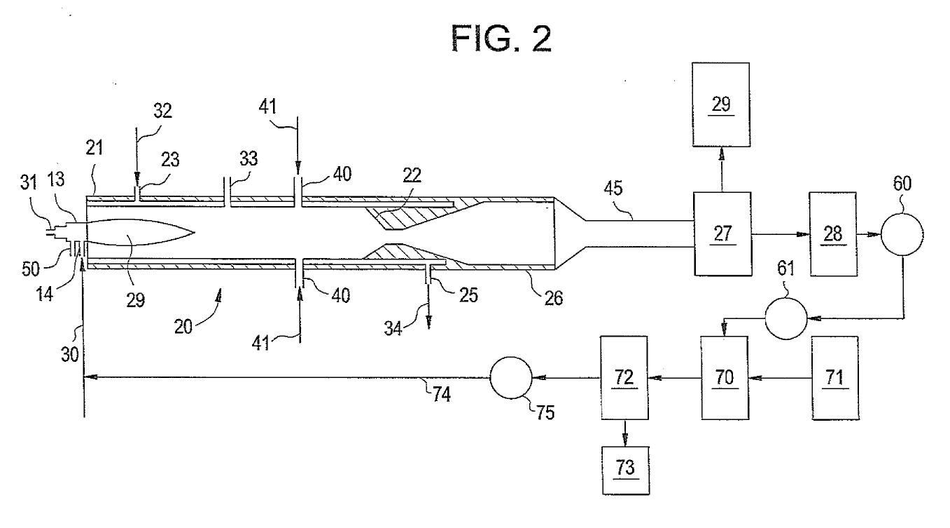

FIG. 2 is a partially schematic sectional diagram of an apparatus for producing ultrafine metal carbide particles in accordance with certain embodiments of the present invention. A plasma chamber 20 is provided that includes a feed inlet 50 which, in the embodiment shown in FIG. 2, is used to introduce a mixture of the metal-containing precursor and carbon-containing precursor into the plasma chamber 20. In another embodiment, the feed inlet 50 may be replaced with one or more separate inlets (not shown) for the metal-containing precursor and carbon-containing precursor. Also provided is at least one carrier gas feed inlet 14, through which a carrier gas flows in the direction of arrow 30 into the plasma chamber 20. The carrier gas may act to suspend or atomize the precursors in the gas, thereby producing a gas-stream with the entrained precursors which flow towards the plasma 29. Numerals 23 and 25 designate cooling inlet and outlet respectively, which may be present for a double-walled plasma chamber 20. In these embodiments, coolant flow is indicated by arrows 32 and 34. At least a portion of the plasma chamber 20 may be thermally insulated.

In the embodiment depicted by FIG. 2, a plasma torch 21 is provided. The torch 21 may thermally decompose or vaporize the metal-containing precursor and carbon-containing precursor within or near the plasma 29 as the stream is delivered through the inlet of the plasma chamber 20, thereby producing a gaseous stream. As is seen in FIG. 2, the precursors are, in certain embodiments, injected downstream of the location where the arc attaches to the annular anode 13 of the plasma generator or torch.

A plasma is a high temperature luminous gas which is at least partially (1 to 100%) ionized. A plasma is made up of gas atoms, gas ions, and electrons. A thermal plasma can be created by passing a gas through an electric arc. The electric arc will rapidly heat the gas by resistive and radiative heating to very high temperatures within microseconds of passing through the arc. The plasma is often luminous at temperatures above 9,000 K.

A plasma can be produced with any of a variety of gases. This can give excellent control over any chemical reactions taking place in the plasma as the gas may be inert, such as argon, helium or neon, reductive, such as hydrogen, methane, ammonia or carbon monoxide, or oxidative, such as oxygen, nitrogen or carbon dioxide.

As the gaseous product stream exits the plasma 29, it proceeds towards the outlet of the plasma chamber 20. An additional reactant, as described earlier, can optionally be injected into the reaction chamber prior to the injection of the quench streams. A supply inlet for the additional reactant is shown in FIG. 2 at 33.

As is seen in FIG. 2, in certain embodiments of the present invention, the gaseous stream is contacted with a plurality of quench streams which enter the plasma chamber 20 in the direction of arrows 41 through a plurality of quench stream injection ports 40 located along the circumference of the plasma chamber 20.

In certain methods of the present invention, contacting the gaseous stream with the quench streams may result in the formation and/or control of the particle size of the ultrafine particles, which are then passed into and through a converging member. As used herein, the term “converging member” refers to a device that restricts passage of a flow therethrough, thereby controlling the residence time of the flow in the plasma chamber due to pressure differential upstream and downstream of the converging member.

In certain embodiments, the converging member comprises a converging-diverging (De Laval) nozzle, such as that depicted in FIG. 2, which is positioned within the outlet of the plasma chamber 20. The converging or upstream section of the nozzle, i.e., the converging member, restricts gas passage and controls the residence time of the materials within the plasma chamber 20. It is believed that the contraction that occurs in the cross sectional size of the stream as it passes through the converging portion of nozzle 22 changes the motion of at least some of the flow from random directions, including rotational and vibrational motions, to a straight line motion parallel to the plasma chamber axis. In certain embodiments, the dimensions of the plasma chamber 20 and the material flow are selected to achieve sonic velocity within the restricted nozzle throat.

As the confined stream of flow enters the diverging or downstream portion of the nozzle 22, it is subjected to an ultra fast decrease in pressure as a result of a gradual increase in volume along the conical walls of the nozzle exit. By proper selection of nozzle dimensions, the plasma chamber 20 can be operated at atmospheric pressure, or slightly less than atmospheric pressure, or, in some cases, at a pressurized condition, to achieve the desired residence time, while the chamber 26 downstream of the nozzle 22 is maintained at a vacuum pressure by operation of a vacuum producing device, such as a vacuum pump 60. Following passage through nozzle 22, the ultrafine metal carbide particles may then enter a cool down chamber 26.

As is apparent from FIG. 2, in certain embodiments of the present invention, the ultrafine metal carbide particles may flow from cool down chamber 26 to a collection station 27 via a cooling section 45, which may comprise, for example, a jacketed cooling tube. In certain embodiments, the collection station 27 comprises a bag filter or other collection means. The particles may then be fed to a powder product container 29. A downstream scrubber 28 may be used if desired to condense and collect material within the flow prior to the flow entering vacuum pump 60.

As shown in FIG. 2, after CO and H₂ gases generated during the plasma heating process are separated from the ultrafine particles in the collection station 27 and pass through the scrubber 28, they are then fed through the pump 60 and a surge tank 61 to a water-gas shift reaction chamber 70. The reaction chamber 70 may be of any suitable conventional design in which parameters such as pressure, temperature, type of catalyst, flowrate (or residence time) and CO concentration are selected by routine techniques known in the art. The surge tank 61 may be used to ensure proper control of pressure in the system. A water chamber 71 feeds water into the reaction chamber 70. The water chamber 71 may be any suitable conventional tank and/or piping design. A separator 72, such as a pressure swing adsorption chamber or a membrane separator, is provided downstream from the reaction chamber 70. Parameters such as operating pressure, adsorptive materials and residence time may be selected by routine techniques known in the art. CO₂ gas exhausted from separator 72 is exhausted to a CO₂ chamber 73. The CO₂ chamber 73 may be of any suitable conventional pressurized tank and/or piping design. Hydrogen is exhausted from separator 72 by hydrogen line 74, which transports at least a portion of the generated hydrogen to the carrier gas flow stream 30. A hydrogen surge tank 75 may be installed in the hydrogen line 74 to control the pressure of the hydrogen. In addition to recirculation of the hydrogen via line 74, at least a portion of the hydrogen generated by the separator may be stored in any suitable pressure vessel for subsequent recirculation to the plasma system 20, or other uses.

In certain embodiments, the residence times for materials within the plasma chamber 20 are on the order of milliseconds. When the metal-containing and carbon-containing precursors are provided in liquid form, they may be injected under pressure (such as from 1 to 300 psi) through a small orifice to achieve sufficient velocity to penetrate and mix with the plasma. In addition, in many cases the injected liquid stream is injected normal (90° angle) to the flow of the plasma gases. In some cases, positive or negative deviations from the 90° angle by as much as 30° may be desired.

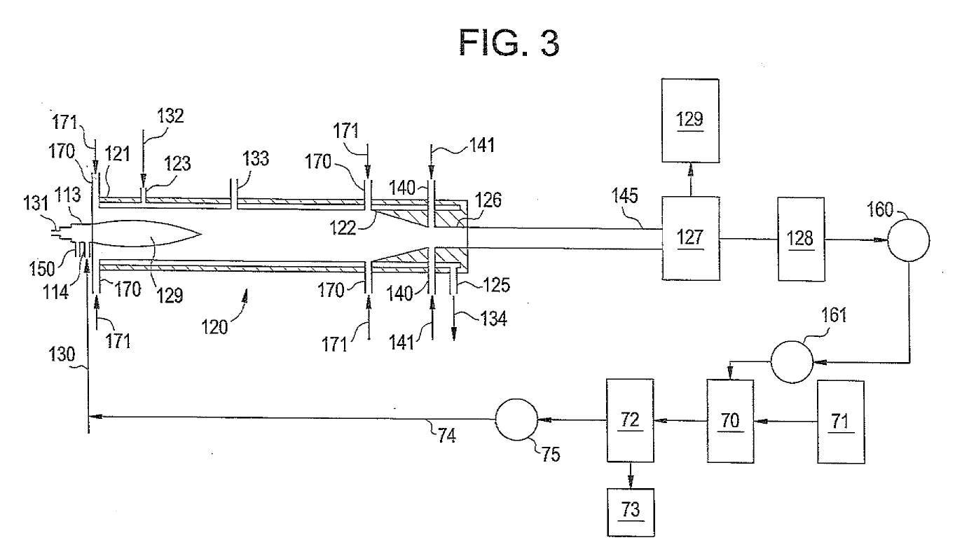

FIG. 3 is a partially schematic diagram of an apparatus for producing ultrafine metal carbide particles in accordance with certain embodiments of the present invention. A plasma chamber 120 is provided that includes a precursor feed inlet 150. Also provided is at least one carrier gas feed inlet 114, through which a carrier gas flows in the direction of arrow 130 into the plasma chamber 120. As previously indicated, the carrier gas acts to suspend the precursor in the gas, thereby producing a gas-stream suspension of the precursor which flows towards plasma 129. Numerals 123 and 125 designate cooling inlet and outlet respectively, which may be present for a double-walled plasma chamber 120. In these embodiments, coolant flow is indicated by arrows 132 and 134. At least a portion of the plasma chamber 120 may be thermally insulated.

In the embodiment depicted by FIG. 3, a plasma torch 121 is provided. Torch 121 thermally decomposes the incoming gas-stream suspension of precursors within the resulting plasma 129 as the stream is delivered through the inlet of the plasma chamber 120, thereby producing a gaseous product stream. As is seen in FIG. 3, the precursors are, in certain embodiments, injected downstream of the location where the arc attaches to the annular anode 113 of the plasma generator or torch.

In FIG. 3, the plasma gas feed inlet is depicted at 131. As the gaseous product stream exits the plasma 129 it proceeds towards the outlet of the plasma chamber 120. As is apparent, a reactant, as described earlier, can be injected into the reaction chamber prior to the injection of the quench streams. A supply inlet for the reactant is shown in FIG. 3 at 133.

As is seen in FIG. 3, in certain embodiments of the present invention, the gaseous product stream is contacted with a plurality of quench streams which enter the plasma chamber 120 in the direction of arrows 141 through a plurality of quench stream injection ports 140 located along the circumference of the plasma chamber 120. As previously indicated, the particular flow rate and injection angle of the quench streams is not limited, for example, they may result in impingement of the quench streams 141 with each other within the gaseous product stream, in some cases at or near the center of the gaseous product stream, to result in the rapid cooling of the gaseous product stream to produce ultrafine particles. This results in a quenching of the gaseous product stream through dilution to form ultrafine particles.

In certain embodiments of the present invention, such as is depicted in FIG. 3, one or more sheath streams are injected into the plasma chamber upstream of the converging member. As used herein, the term “sheath stream” refers to a stream of gas that is injected prior to the converging member and which is injected at flow rate(s) and injection angle(s) that result in a barrier separating the gaseous product stream from the plasma chamber walls, including the converging portion of the converging member. The material used in the sheath stream(s) is not limited, so long as the stream(s) act as a barrier between the gaseous product stream and the converging portion of the converging member, as illustrated by the prevention, to at least a significant degree, of material sticking to the interior surface of the plasma chamber walls, including the converging member. For example, materials suitable for use in the sheath stream(s) include, but are not limited to, those materials described earlier with respect to the quench streams. A supply inlet for the sheath stream is shown in FIG. 3 at 170 and the direction of flow is indicated by numeral 171.

By proper selection of the converging member dimensions, the plasma chamber 120 can be operated at atmospheric pressure, or slightly less than atmospheric pressure, or, in some cases, at a pressurized condition, to achieve the desired residence time, while the chamber 126 downstream of the converging member 122 is maintained at a vacuum pressure by operation of a vacuum producing device, such as a vacuum pump 60. Following production of the ultrafine particles, they may then enter a cool down chamber 26. The system may be operated under vacuum or under pressure. For example, a vacuum pump may be used downstream from the particle separator to provide vacuum to the system. Alternatively, the system can be purged with gas to increase the pressure.

As is apparent from FIG. 3, in certain embodiments of the present invention, the ultrafine particles may flow from cool down chamber 126 to a collection station 127 via a cooling section 145, which may comprise, for example, a jacketed cooling tube. In certain embodiments, the collection station 127 comprises a bag filter or other collection means. The particles may then be fed to a powder product container 129. A downstream scrubber 128 may be used if desired to condense and collect material within the flow prior to the flow entering vacuum pump 160.

As shown in FIG. 3 after CO and H₂ gases generated during the plasma heating process are separated from the ultrafine particles in the collection station 127 and pass through the scrubber 128, they are then fed through the pump 160 and a surge tank 161 to a water-gas shift reaction chamber 70 as described above. The surge tank 161 may be used to ensure proper control of pressure in the system. A water chamber 71 feeds water into the reaction chamber 70, and a separator 72, such as a pressure swing adsorption chamber or a membrane separator, is provided downstream from the reaction chamber 70. CO₂ gas is exhausted from separator 72 to a CO₂ chamber 73. Hydrogen is exhausted from separator 72 by hydrogen line 74, which transports at least a portion of the generated hydrogen to the carrier gas flow stream 30. A hydrogen surge tank 75 may be installed in the hydrogen line 74 to control the pressure of the hydrogen. In addition to recirculation of the hydrogen via line 74, at least a portion of the hydrogen generated by the separator may be stored in any suitable pressure vessel for subsequent recirculation to the plasma system 20, or other uses.

The precursors may be injected under pressure (such as greater than 1 to 100 atmospheres) through a small orifice to achieve sufficient velocity to penetrate and mix with the plasma. In addition, in many cases the injected stream of precursors is injected normal (90° angle) to the flow of the plasma gases. In some cases, positive or negative deviations from the 90° angle by as much as 30° may be desired.

The high temperature of the plasma may rapidly decompose and/or vaporize the precursors. There can be a substantial difference in temperature gradients and gaseous flow patterns along the length of the plasma chamber. It is believed that, at the plasma arc inlet, flow is turbulent and there is a high temperature gradient from temperatures of about 20,000 K at the axis of the chamber to about 375 K at the chamber walls. At the nozzle throat, it is believed, the flow is laminar and there is a very low temperature gradient across its restricted open area.

The plasma chamber is often constructed of water cooled stainless steel, nickel, titanium, copper, aluminum, or other suitable materials. The plasma chamber can also be constructed of ceramic materials to withstand a vigorous chemical and thermal environment.

The plasma chamber walls may be internally heated by a combination of radiation, convection and conduction. In certain embodiments, cooling of the plasma chamber walls prevents unwanted melting and/or corrosion at their surfaces. The system used to control such cooling should maintain the walls at as high a temperature as can be permitted by the selected wall material, which often is inert to the materials within the plasma chamber at the expected wall temperatures. This is true also with regard to the nozzle walls, which may be subjected to heat by convection and conduction.

The length of the plasma chamber is often determined experimentally by first using an elongated tube within which the user can locate the target threshold temperature. The plasma chamber can then be designed long enough so that the materials have sufficient residence time at the high temperature to reach an equilibrium state and complete the formation of the desired end products.

The inside diameter of the plasma chamber may be determined by the fluid properties of the plasma and moving gaseous stream. It should be sufficiently great to permit necessary gaseous flow, but not so large that recirculating eddys or stagnant zones are formed along the walls of the chamber. Such detrimental flow patterns can cool the gases prematurely and precipitate unwanted products. In many cases, the inside diameter of the plasma chamber is more than 100% of the plasma diameter at the inlet end of the plasma chamber.

In certain embodiments, the converging section of the nozzle has a high aspect ratio change in diameter that maintains smooth transitions to a first steep angle (such as >45°) and then to lesser angles (such as <45°) leading into the nozzle throat. The purpose of the nozzle throat is often to compress the gases and achieve sonic velocities in the flow. The velocities achieved in the nozzle throat and in the downstream diverging section of the nozzle are controlled by the pressure differential between the plasma chamber and the section downstream of the diverging section of the nozzle. Negative pressure can be applied downstream or positive pressure applied upstream for this purpose. A converging-diverging nozzle of the type suitable for use in the present invention is described in U.S. Pat. No. RE37,853 at col. 9, line 65 to col. 11, line 32, the cited portion of which being incorporated by reference herein.

It will be readily appreciated by those skilled in the art that modifications may be made to the invention without departing from the concepts disclosed in the foregoing description. Such modifications are to be considered as included within the following claims unless the claims, by their language, expressly state otherwise. Accordingly, the particular embodiments described in detail herein are illustrative only and are not limiting to the scope of the invention which is to be given the full breadth of the appended claims and any and all equivalents thereof.

We claim:

1. A method for producing ultrafine metal carbide particles and hydrogen comprising:
introducing a metal-containing precursor and a carbon-containing precursor into a thermal reaction chamber;
heating the precursors in the thermal reaction chamber to form the ultrafine metal carbide particles from the precursors and to form carbon monoxide and hydrogen;
collecting the ultrafine metal carbide particles;
converting at least a portion of the carbon monoxide to carbon dioxide and generating additional hydrogen; and
recovering at least a portion of the hydrogen.

2. The method of claim 1, wherein the thermal reaction chamber comprises a plasma.

3. The method of claim 1, wherein the metal carbide comprises boron carbide, tungsten carbide, titanium carbide, silicon carbide, aluminum carbide, iron carbide, and zirconium carbide.

4. The method of claim 1, wherein the metal carbide comprises boron carbide.

5. The method of claim 1, wherein the ultrafine metal carbide particles comprise B₄C, B₁₃C₂, B₈C, B₁₀C and/or B₂₅C.

6. The method of claim 1, wherein the ultrafine metal carbide particles comprise B₄C.

7. The method of claim 1, wherein the ultrafine metal carbide particles have an average particle size of less than 100 nm.

8. The method of claim 1, wherein the metal-containing precursor is introduced in solid form.

9. The method of claim 8, wherein the solid metal-containing precursor comprises B₂O₃ powder.

10. The method of claim 1, wherein the carbon-containing precursor is introduced in solid form.

11. The method of claim 10, wherein the solid carbon-containing precursor comprises C powder.

12. The method of claim 1, wherein the carbon-containing precursor is introduced in gaseous form.

13. The method of claim 12, wherein the gaseous carbon-containing precursor comprises a hydrocarbon.

14. The method of claim 12, wherein the gaseous carbon-containing precursor comprises CH₄.

15. The method of claim 1, further comprising contacting the metal-containing precursor and carbon-containing precursor with a carrier gas.

16. The method of claim 15, wherein the carrier gas comprises H₂.

17. The method of claim 1, wherein the carbon monoxide is converted to carbon dioxide by a water-gas shift reaction.

18. The method of claim 1, further comprising separating hydrogen from the carbon dioxide.

19. The method of claim 18, wherein the hydrogen and carbon dioxide are separated by membrane separation.

20. The method of claim 18, wherein at least a portion of the separated hydrogen is recycled into the thermal reaction chamber.

21. The method of claim 20, wherein the recycled hydrogen is used as a carrier gas for at least one of the precursors.

22. The method of claim 20, wherein the recycled hydrogen is used as a plasma gas during the formation of the ultrafine metal carbide particles.

23. The method of claim 20, wherein the recycled hydrogen is used as a sheath gas for at least one of the precursors.

24. The method of claim 20, wherein the recycled hydrogen is used as a quench gas for at least one of the precursors.

25. The method of claim 18, further comprising storing at least a portion of the separated hydrogen.

26. An ultrafine metal carbide powder produced by the method of claim 1.

27. A system for producing ultrafine metal carbide particles and hydrogen comprising:
a source of metal-containing precursor;
a source of carbon-containing precursor;
means for introducing the metal-containing precursor and carbon-containing precursor into a thermal reaction chamber to form the ultrafine metal carbide particles from the precursors and to form carbon monoxide and hydrogen; and
means for converting at least a portion of the carbon monoxide to carbon dioxide and generating additional hydrogen.
